(19) United States
(12) Patent Application Publication
(10) Pub. No.: US 2025/0330887 A1
(43) Pub. Date: Oct. 23, 2025

(54) SYSTEMS AND METHODS FOR PERFORMING A NETWORK HANDOVER BETWEEN WIFI AND NON-WIFI NETWORKS

(71) Applicant: PLUME DESIGN, INC., Palo Alto, CA (US)

(72) Inventors: Saidhiraj AMURU, Telagana (IN); Badri Srinivasan SAMPATHKUMAR, Fremont, CA (US); Mohamed AL MASRI, Folsom, CA (US)

(21) Appl. No.: 18/641,264

(22) Filed: Apr. 19, 2024

(51) Int. Cl. H04W 36/14

(52) U.S. Cl. CPC H04W 36/1446

(57) ABSTRACT

Disclosed are systems and methods that provide a computerized network management framework that provides novel network functionality for devices connected to and/or operating in proximity to WiFi and non-WiFi networks. The framework provides functionality for all types of network traffic to be handled properly and handed over between two networks seamlessly with minimal interruptions. The disclosed framework operates to transition a device's connection to a non-WiFi network (e.g., cellular network) from a WiFi network, and vice versa. Such performance of such functionality can correspond to, but is not limited to, network characteristics, parameters and/or attributes, network health, and the like, as well as geospatial positioning of the device, inclusive of the device's movement, which can be in relation to an access point or gateway for a network.

### FIELD OF THE DISCLOSURE

The present disclosure is generally related to network management, and more particularly, to a decision intelligence (DI)-based computerized framework for performing a handover by and between Wireless Fidelity (WiFi or Wi-Fi) and non-WiFi systems (e.g., cellular networks).

### SUMMARY OF THE DISCLOSURE

Disclosed are computerized systems and methods for a network management framework that provides novel network optimization for Wireless Fidelity (WiFi or Wi-Fi) networks. As discussed herein, the disclosed systems and methods provide functionality for all types of network traffic to be handled properly and handed over between two networks seamlessly with minimal interruptions. The disclosed framework operates to transition a device's connection to a non-WiFi network (e.g., cellular network) from a WiFi network, and vice versa. As discussed herein, according to some embodiments, the performance of such functionality can correspond to, but is not limited to, network characteristics, parameters and/or attributes, network health, and the like, as well as geospatial positioning of the device, inclusive of the device's movement, which can be in relation to an access point or gateway for a network.

According to some embodiments, a method is disclosed for performing DI-based handovers by and between WiFi and non-WiFi systems. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for performing DI-based handovers by and between WiFi and non-WiFi systems.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1A is a block diagram of an example configuration within which the systems and methods disclosed herein could be implemented according to some embodiments of the present disclosure;

FIG. 1B is a block diagram illustrating components of an exemplary system according to some embodiments of the present disclosure;

FIG. 2 depicts a non-limiting example embodiment according to some embodiments of the present disclosure;

FIG. 3 depicts a non-limiting example embodiment according to some embodiments of the present disclosure;

FIGS. 4A-4B depict non-limiting example embodiments according to some embodiments of the present disclosure;

FIG. 5 illustrates an exemplary workflow according to some embodiments of the present disclosure;

FIG. 6 depicts a non-limiting example embodiment according to some embodiments of the present disclosure;

FIG. 7 depicts a non-limiting example embodiment according to some embodiments of the present disclosure;

FIGS. 8A-8B depict non-limiting example embodiments according to some embodiments of the present disclosure;

FIG. 9 depicts a non-limiting example embodiment according to some embodiments of the present disclosure;

FIG. 10 illustrates an exemplary workflow according to some embodiments of the present disclosure;

FIG. 11 depicts a non-limiting example embodiment according to some embodiments of the present disclosure;

FIG. 12 depicts a non-limiting example embodiment according to some embodiments of the present disclosure;

FIGS. 13A-13B depict non-limiting example embodiments according to some embodiments of the present disclosure;

FIG. 14 depicts an exemplary implementation of an architecture according to some embodiments of the present disclosure;

FIG. 15 depicts an exemplary implementation of an architecture according to some embodiments of the present disclosure; and

FIG. 16 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/a/g/n/ac/ax/be, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

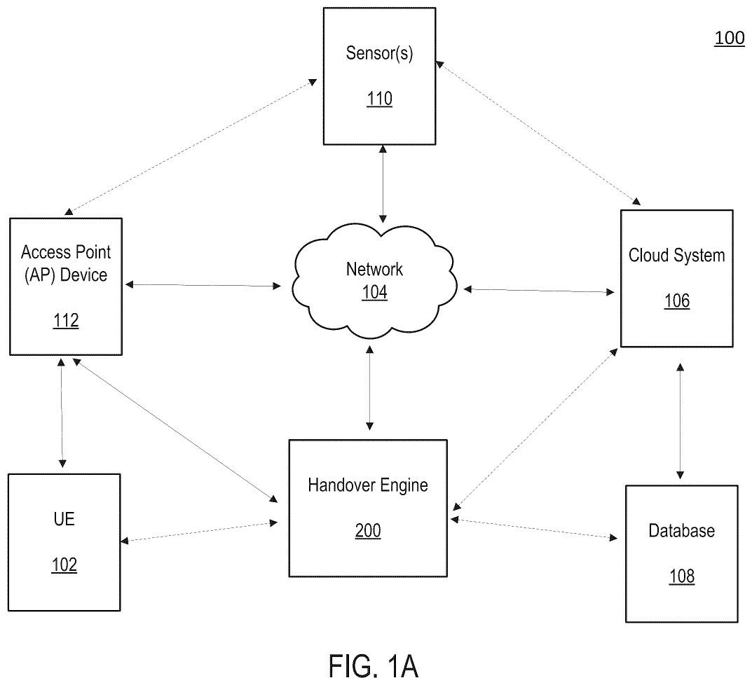

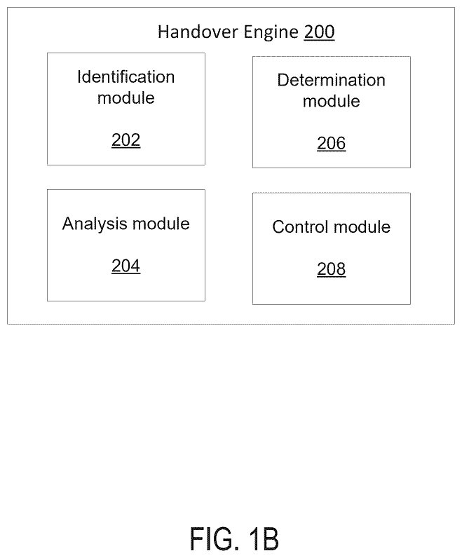

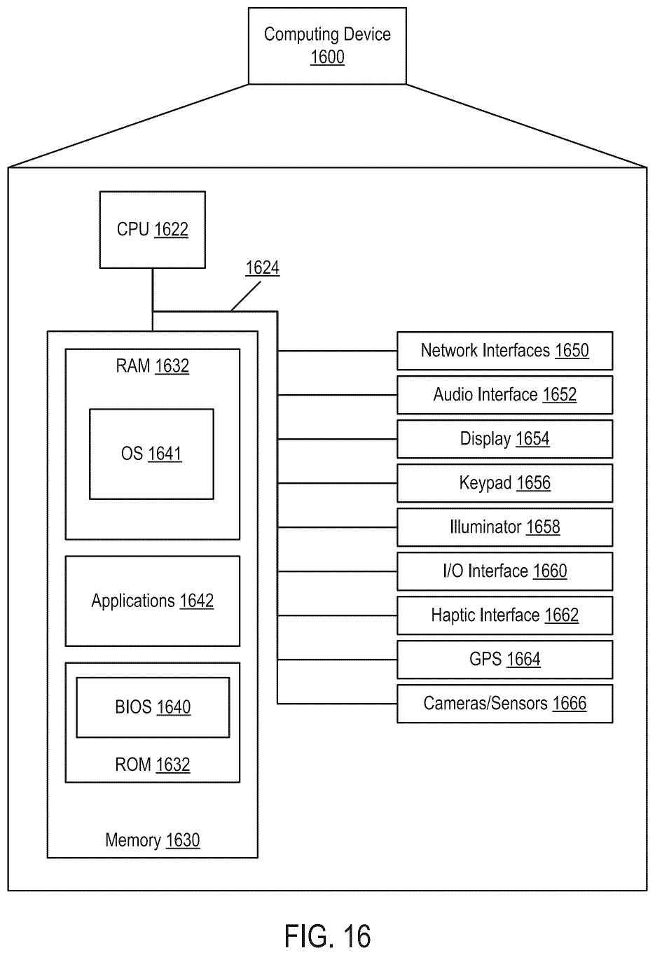

Certain embodiments and principles will be discussed in more detail with reference to the figures. With reference to FIG. 1A, system 100 is depicted which includes user equipment (UE) 102 (e.g., a client device, as mentioned above and discussed below in relation to FIG. 16), AP device 112, network 104, cloud system 106, database 108, sensors 110 and handover engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1A.

According to some embodiments, UE 102 can be any type of device, such as, but not limited to, a mobile phone, tablet, laptop, sensor, Internet of Things (IoT) device, wearable device, autonomous machine, smart television, media streaming device, game console, and any other device equipped with a cellular or wireless or wired transceiver.

In some embodiments, peripheral devices (not shown) can be connected to UE 102, and can be any type of peripheral device, such as, but not limited to, a wearable device (e.g., smart ring, smart watch, for example), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

According to some embodiments, sensors 110 can correspond to any type of device, component and/or sensor associated with a location of system 100 (referred to, collectively, as “sensors”). In some embodiments, the sensors 110 can be any type of device that is capable of sensing and capturing data/metadata related to activity of the location. For example, the sensors 110 can include, but not be limited to, cameras, motion detectors, door and window contacts, heat and smoke detectors, passive infrared (PIR) sensors, time-of-flight (ToF) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof. For example, the sensors 110 can include the sensors on UE 102 (e.g., smart phone) and/or peripheral device (e.g., a paired smart ring). In some embodiments, sensors 110 can be associated with any device connected and/or operating on cloud system 106 (e.g., a cloud-based device, such as a server that collects information related to the location, for example).

In some embodiments, network 104 can be any type of network, such as, but not limited to, a wireless network, cellular network, the Internet, and the like (as discussed above). Network 104 facilitates connectivity of the components of system 100, as illustrated in FIG. 1A.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider (e.g., Plume Design®, for example), which has associated network resources hosted on the internet or private network (e.g., network 104), which enables (via engine 200) the network management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, sensors 110, and the services and applications provided by cloud system 106 and/or handover engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

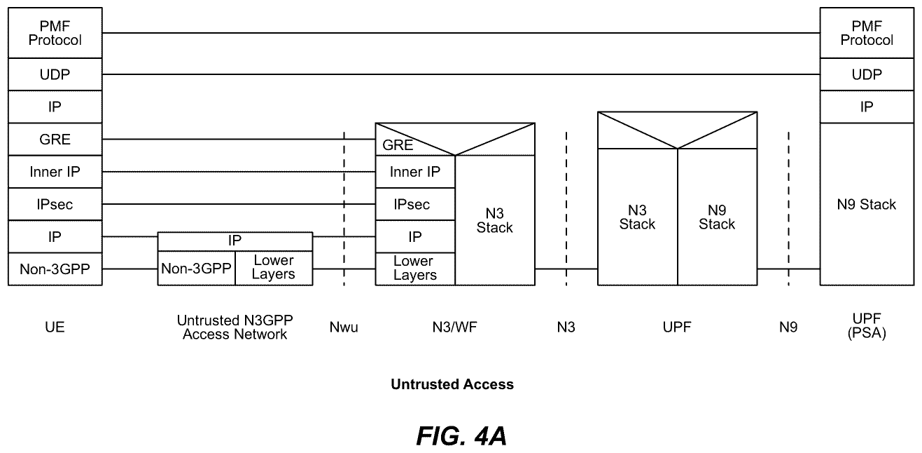

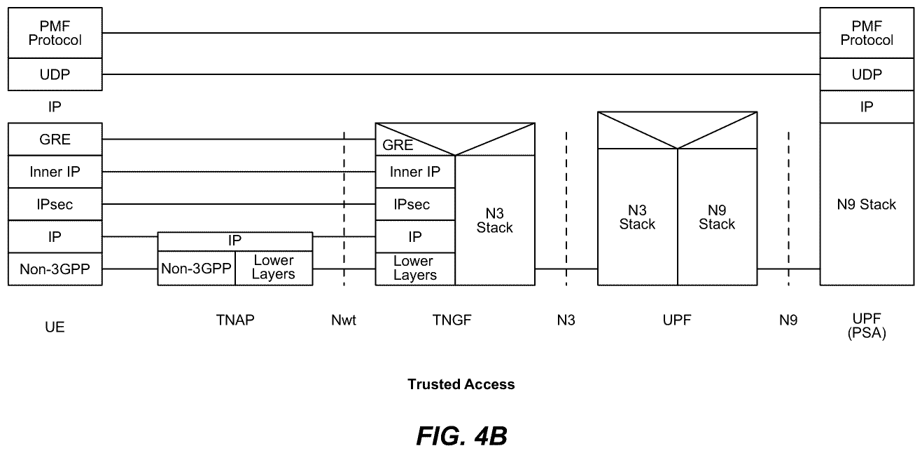

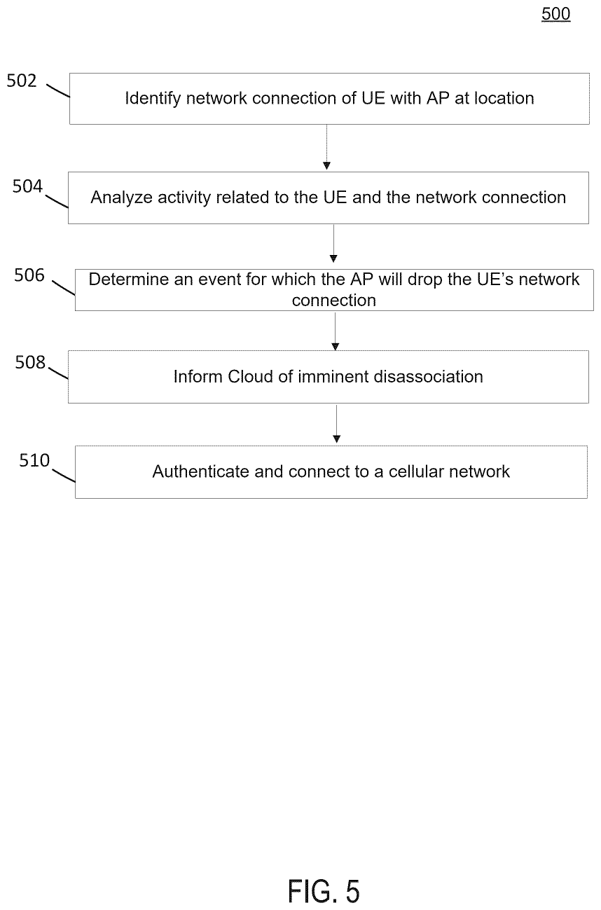

Turning to FIGS. 4 and 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIGS. 4 and 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1A, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, structured query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Handover engine 200, as discussed above and further below in more detail, can include components for the disclosed functionality. According to some embodiments, handover engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

According to some embodiments, as discussed in more detail below, handover engine 200 may be configured to implement and/or control a plurality of services and/or microservices, where each of the plurality of services/microservices are configured to execute a plurality of workflows associated with performing the disclosed network management. Non-limiting embodiments of such workflows are discussed and provided below.

According to some embodiments, as discussed above, handover engine 200 may function as an application provided by cloud system 106. In some embodiments, engine 200 may function as an application installed on a server(s), network location and/or other type of network resource associated with system 106. In some embodiments, engine 200 may function as an application installed and/or executing on AP device 112 and/or UE 102 (and/or sensors 110). In some embodiments, such application may be a web-based application accessed by AP device 112 and/or UE 102, and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on AP device 112, UE 102 and/or sensors 110.

As illustrated in FIG. 1B, according to some embodiments, handover engine 200 includes identification module 202, analysis module 204, determination module 206 and control module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

By way of background, many devices currently have both cellular and WiFi capabilities. For example, a cellular phone can have both 4G/5G and WiFi abilities. Such devices constantly move between home WiFi networks and cellular networks when they roam outside the home (or a location for which they are connected to a WiFi network—for example, a coffee shop, work, and the like).

By way of an example, many times, the cellular coverage can be poor inside the location for which a device is connected to WiFi (e.g., a garage of a home, foyer, entryway, and the like) when the device enters indoors from outdoors, which may lead to loss of coverage on the 5G network and may lead to loss of service disruption before the connection is made back to the WiFi network. Similarly, when the device is moving from indoors to outdoors, where, initially the device is connected to the home WiFi network, and the device moves outdoors, the WiFi connection is lost and/or may lead to loss of service before connecting to the outdoor cellular network. As one who has experienced using a mobile device on WiFi and/or cellular network, this may lead to considerable loss in Quality of Experience (QOE) and service quality, among other drawbacks, if not handled properly.

Currently, implementations on the device side (UE side) involve an application (“app”) handling the transition between WiFi and cellular, which can be based on the signal strength and other relevant metrics. However, this is not widely used for data traffic. Furthermore, there are technical shortcomings in that having control on the UE side may not be computationally and/or electronic resource-focused efficiently, as it can depend on the UE type for this feature to work well.

Therefore, the disclosed systems and methods provide a novel technical solution that provide advanced mechanisms for detecting the need for a network handover, as well as executing such handover properly and efficiently (e.g., with minimal connectivity disruptions, for example). Thus, rather than relying on client-side controls (e.g., UE-sided or based), the disclosed framework provides functionality for cloud-based controls via a cloud-based architecture that integrates with WiFi access points (APs) and can communicate with cellular masters when required.

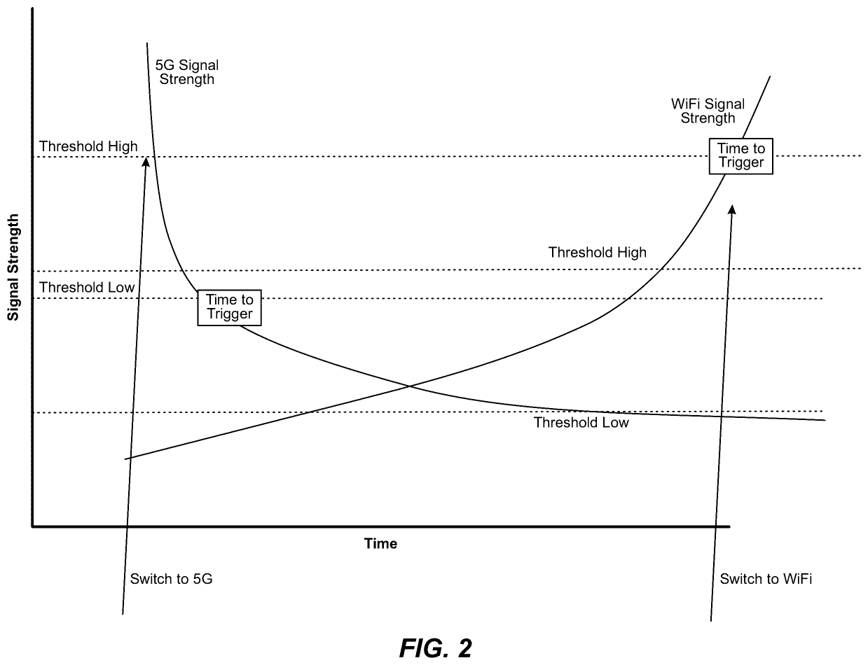

By way of a non-limiting example, as depicted in FIG. 2, as the 5G signal strength drops and approaches a low threshold for a given amount of time, as shown per the “Time To Trigger” label, the disclosed functionality via the disclosed framework can operate, thereby effectuating a smooth handover. FIG. 2 depicts an example of RSSI patterns across various radio access networks (RANs). Therefore, for example, if the 5G signal strength is below a low threshold for a particular amount of time, and if the WiFi signal strength is above a particular threshold, then connectivity for a device can be switched to WiFi, and vice versa.

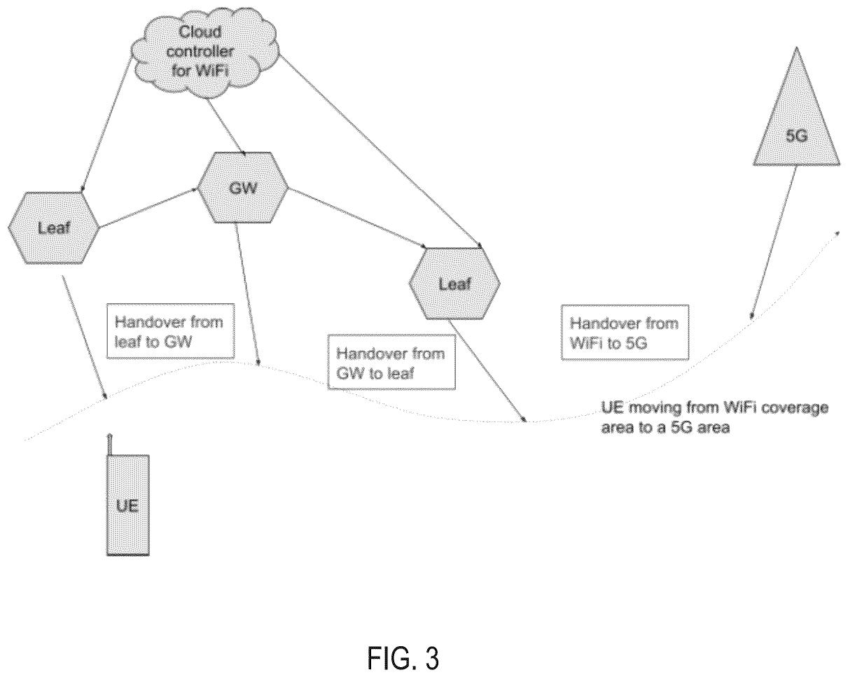

Currently, with proprietary implementations on the device side, an application can handle the transition for WiFi and cellular using the signal strength and other relevant metrics. However, this is not widely used for data traffic. Furthermore, having control on the device side may not be efficient and may depend on the device type for this feature to work. Accordingly, in order for the handover to be handled properly and efficiently for all device types and all kinds of traffic, as discussed herein, it is better to have control on the Cloud which handles the WiFi APs in a cloud-based architecture which can have the ability to talk to the cellular network masters when required. An example of this is depicted in FIG. 3.

By way of a non-limiting example, as illustrated in the example deployment setting in FIG. 3, each arrow to the dotted line indicates the region where the depicted UE may be connected to various devices along its path. According to some embodiments, as discussed herein, as long as possible the UE may be connected to the WiFi network and is steered from one WiFi AP to another AP by the cloud controller (e.g., engine 200, as discussed below). Once beyond the coverage of all APs, then UE will be handed over to the non-Wi-Fi network (e.g., cellular network—5G as illustrated in FIG. 3.

According to some embodiments, as discussed herein, there are two (2) kinds of deployment mechanisms to support the disclosed 5G/WiFi handover: i) trusted deployments and ii) non-trusted deployments.

In some embodiments, in the case of untrusted deployments, the data traffic can be routed via any AP to the 5G core network using tunnels and Internet Protocol Security (IPSEC) protocols that eventually end up on the 5G core network. The role of the WiFi APs in this case is forwarding the traffic across without any specific interventions. The onus is on the UE to create the IPSEC tunnel and send the traffic via that tunnel. In some embodiments, a tunnel establishment procedure can be informed by the 5G network to the UE, and such specific IP/DNS names can be used by the UE to establish the specific tunnels. According to some embodiments, known or to be known encryption can be used.

In some embodiments, in the case of trusted deployments, the IPSEC tunnels can be formed in a similar manner with null security. In some embodiments, as in case of trusted deployments, the same credentials can be used for authentication in 5G and Wi-Fi networks. Accordingly, in both cases, the IPSEC tunnel can be commonly used; however, authentication operations may vary. In some embodiments, for a trusted Wi-Fi AP based on UE ability, the UE can send a query via Access Network Query Protocol (ANQP) and discover the WiFi AP to connect to. In some embodiments, in the case of a trusted connection, WiFi APs can send Public Land Mobile Network (PLMN) codes/lists, for example, for UE to match to, whereby, if the PLMN of a 5G network matches with the information advertised by the AP and the information stored in the SIM card, the UE can attach to such APs. In some embodiments, such tunnels can be used when a UE attaches via Wi-Fi APs.

According to some embodiments, as discussed below in more detail, such for the trusted and non-trusted deployments can be performed based on traffic types and/or generic for all traffic types, which can be defined by the UE implementations and/or by the 5G network providers as well. By way of a non-limiting example, FIGS. 4A and 4B depict Open System Intercommunication (OSI) layers for each deployment, respectively.

As in FIG. 4A, in the un-trusted case, only an IPSEC tunnel is formed. No specific information about valid cellular networks is broadcasted by the untrusted AP to the UE. The UE has to scan all networks when it wants to make alternate connections or handovers. In the untrusted case, an IP address is assigned by the AP itself. Therefore for the handover case, when it switches from 5G to WiFi and vice versa, IP address assignment has to take place which may be causing disruptive changes in the session connection and service discontinuity.

In FIG. 4B, in the trusted case, in addition to the IPSEC tunnel, the UE is given information about all neighbor networks using the ANQP protocol. Various information can be obtained such as, for example, neighbors, public land mobile network (PLMN) IDs, signal strengths, latency behaviors, and the like, which can significantly aid the UE handover process. In addition, the IP address assignment is performed with the help of DHCP servers sitting behind the wireless access gateway which directly talks with the cellular backend. In such a case, the same IP address can be sustained even after handover across the multiple radio access networks and therefore minimize the disruption.

Turning to FIG. 5, Process 500 provides non-limiting example embodiments for the disclosed network management framework. As discussed herein, the disclosed implementation for Process 500 relates to an “indoor to outdoor” handover, or, for example, WiFi to cellular handover.

According to some embodiments, Step 502 of Process 500 can be performed by identification module 202 of handover engine 200; Step 504 can be performed by analysis module 204; Step 506 can be performed by determination module 206; and Steps 508-510 can be performed by control module 208.

According to some embodiments, Process 500 begins with Step 502 where engine 200 can identify a network connection of the UE (e.g., mobile device) with an AP at a location (e.g., a user's home, for example). The network connection, for example, as discussed above, can be a Wi-Fi network associated with the location.

In Step 504, engine 200 can collect data related to the activity of the UE, which can relate to, but is not limited to, real-world activity (e.g., movement, for example) and/or digital activity (e.g., network resources interacted with, for example). Such network activity, as discussed below, can be effectuated and/or collected via the network connection.

According to some embodiments, engine 200 can analyze the collected activity data by engine 200 executing a specific trained artificial intelligence (AI)/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
define Neural Network architecture/model,
transfer the input data to the neural network model,
train the model incrementally,
determine the accuracy for a specific number of timesteps,
apply the trained model to process the newly received input data,
optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Thus, based on the analysis of the collected data, in Step 506 engine 200 can determine an event or which the AP will drop (e.g., predict and/or project a time and/or cause for) the UE from the network connection, as discussed below. Accordingly, in Step 508, engine 200 can inform the cloud of an imminent disassociation of the UE from the AP (and network connection), whereby, in Step 510, engine 200 can effectuate a disassociation operation from the AP (and WiFi network) and perform authentication and connection of the UE with a cellular network (e.g., 5G network, for example).

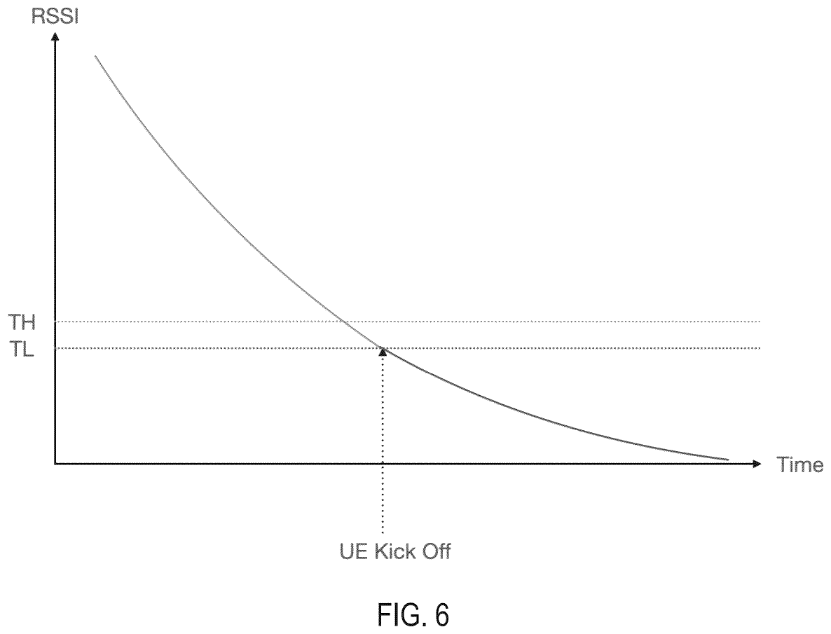

Turning to FIGS. 6-9, depicted are examples of the embodiments that correspond to the functionality provided in Process 500 of FIG. 5, discussed supra.

With regard to FIG. 6, depicted is a graph showing WiFi RSSI values for a device's movement. That is, as a UE (e.g., client device) is moving out of the Wi-Fi network into the 5G network, the engine 200 can initially attempt to steer to all the possible Wi-Fi APs before it determines the UE cannot be handled within the WiFi coverage domain. In some embodiments, for example, the RSSI of the UE at every AP at the location (GW and all the leaf pods) have fallen below the configured threshold values. This indicates that the UE has moved closer to the boundary/periphery of the coverage area of the WiFi.

Accordingly, in some embodiments, instead of making the UE disconnect from the Wi-Fi network after things have gone bad with regard to signal strength, among other network characteristics, engine 200 can predict that the UE is moving out of Wi-Fi coverage zone.

In some embodiments, if the UE is inactive, engine 200 can disconnect/disassociate (e.g., disassociation operation) the UE from the WiFi once its RSSI crosses down the high threshold (TH), as depicted in FIG. 6. To avoid a “ping-pong” behavior (of bouncing between connection types), engine 200 can apply a backoff timer (typically known as time to trigger or hysteresis timer) to block the UE from associating back to WiFi if its RSSI crosses up the high threshold again.

In some embodiments, as discussed herein, the disclosed framework can implement mechanisms for “blacklisting” so as to prevent a UE from re-associating back to an AP. Such mechanisms can involve using the wireless network management (NWM) action frames (e.g., BSS Transition Management frame or Wireless Network Management Request frame, and the like). Thus, in some embodiments, alternative to blacklist UE(s), an AP can use wireless network management (NWM) action frames (e.g., BSS Transition Management frame or WNM Request frame) to prevent UE's from re-associating to the AP for a certain time.

In some embodiments, if the UE is active, on the other hand, engine 200 can delay removing the UE off the WiFi until the WiFi RSSI crosses below the low threshold (TL), as depicted in FIG. 6.

According to some embodiments, UE traffic behaviors can be monitored before performing any decisions (as per Step 504, discussed supra). In some embodiments, for example, for idle UEs, 802.11k and 802.11v can be used to obtain RSSI reports from the UE to get finer statistics before making such decisions.

According to some embodiments, such predictions by engine 200 (e.g., controller) of disconnection can correspond to a time required for the UE to move out of the WiFi coverage area, which can correlate to a disassociation imminent criteria and/or a disassociation timer. Accordingly, such criteria can provide an indication to the UE that it will be kicked off the Wi-Fi network. In some embodiments, a determined decision to disassociate (or “kick off”) may be based on a timer, where the value of the timer may be based on AI/ML predicted results as they pertain to the analyzed movement of the UE. In some embodiments, the timer may initially be set to a large value, and as the signal strength starts falling (e.g., at a predetermined and/or satisfying a threshold rate) below the threshold, engine 200 can send can trigger to kick the UE of the network. Once this is received, the UE has to arrange/ensure session connectivity, and thereby it will handover to the 5G network. In some embodiments, the uplink data stream may be adjusted by the UE to thereafter flow via the 5G tunnels.

According to some embodiments, disconnection can be based on and/or correlated to a disassociation reason code and/or deauthentication reason code. Such codes, for example, can be related to the UE being unable to connect (e.g., maintain connection) to the AP, and/or the AP is not currently able to handle the UE (e.g., AP lacks QoS of sufficient bandwidth). According to some embodiments, APs can add the UE(s) to an access control list, which can enable the AP to permit or deny the UE(s) from connecting to the WiFi network by way of blocking various messages in the connection protocol. Accordingly, when determined to be permitted, the UE(s) may be unblocked and enabled to reconnect to the network again.

According to some embodiments, in the case of downlink traffic flowing from the Internet to the UE, either a service disruption can be seen, or if engine 200 can establish connection with the cellular backend, such as the 5G core network, for example, engine 200 can inform the 5G core network that the UE will be kicked off and an alternate routing path may be established with the cellular network to avoid network disruptions.

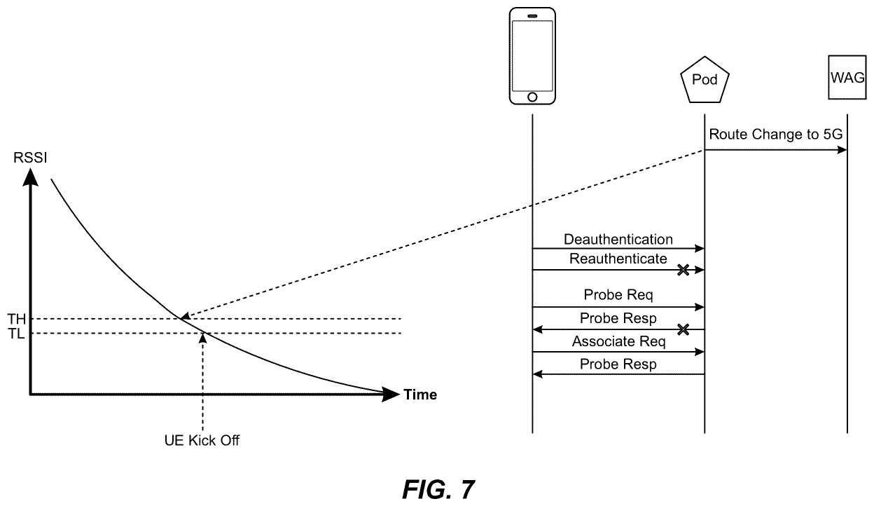

According to some embodiments, a redirecting the data path is usually controlled by the AMF. Since the wireless access gateway (WAG), trusted WLAN internetworking function (TWIF), or trusted non-3GPP gateway function (TNGF) are the WiFi liaison with the 5G Core, the request can be sent via such components. FIG. 7 depicts a non-limiting example where a route change can be achieved by engine 200 informed via the AP device (“Pod”) (in FIG. 7, the y-axis represents the WiFi RSSI related to WiFi to 5G route redirection for a UE). In some embodiments, for seamless connectivity, an AP can send a server (e.g., radius server) (or a node or controlling network device on the network) a message to stop accounting (e.g., for WAN Metrics (HS 2.0 ANQP-element, for example), which can indicate that the AP does not have the capacity and/or capabilities to currently handle a UE(s).

In some embodiments, in the case of the uplink (UL) traffic, since the UE is being informed about imminent disassociation from the WiFi network, engine 200 can route the UL traffic appropriately within its Wi-Fi and cellular stacks. Typical UE implementations have an app/piece of code running in their software, which will make such decisions for them. However, the engine 200's cloud components can inform the 5G core that this may happen and also inform the 5G core to assist the UE in creating such UPLINK tunnels.

In some embodiments, with regard to untrusted WiFi, the UE can switch to the 5G network and then it can end the IPSEC tunnel it formed via WiFi to the 5G core network of the cellular network. In some embodiments, in the case of trusted network, the UE can do the same, but with support from the 5G core, this can be performed seamlessly as opposed to the untrusted case, in that engine 200 can inform the 5G core network about its decisions and the 5G core network can be prepared for this switch.

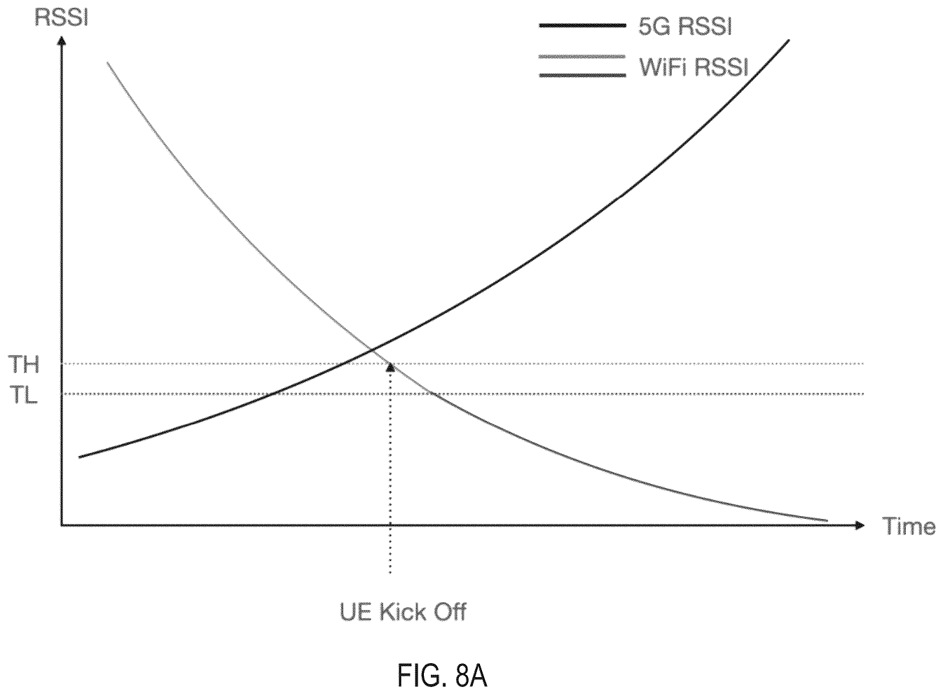

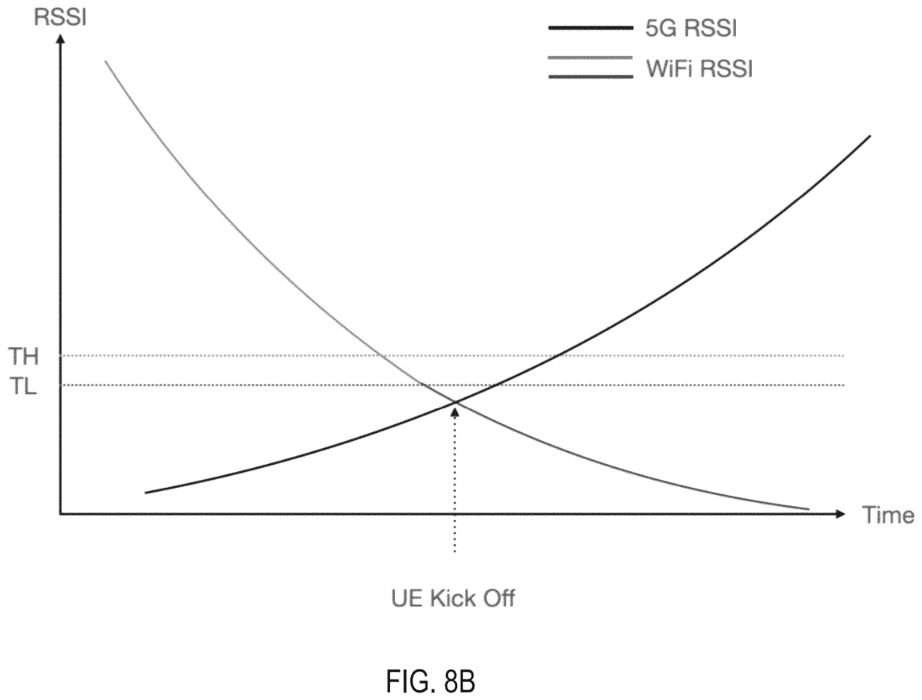

According to some embodiments, the above described technical solutions relate to when no 5G information is available to engine 200, as depicted in FIGS. 8A and 8B, below are mechanisms where 5G statistics are available. There are two cases: 1) Case 1: If 5G link quality (or any handover (HO) criteria, for example, RSSI SNR, delay or any other type of metrics related to link quality, or some combination thereof) is better than that of WiFi link quality, the HO is initiated when 5G link quality crosses up the high threshold; and 2) Case 2: When 5G link quality (or any HO criteria, for example, RSSI, SNR, delay or any other type of metrics related to link quality, or some combination thereof) is worse than that of WiFi, the HO is initiated when WiFi crosses below the low threshold and even when WiFi RSSI is better than 5G.

FIG. 8A depicts Case 1; and FIG. 8B depicts Case 2.

Accordingly, in some embodiments, engine 200 knows the activity of the UE (as per Steps 5040-506 of Process 500, discussed supra); therefore, engine 200 can initiate the HO if it detects that the UE is eventually moving towards the WiFi coverage. In some embodiments, when 5G statistics are available, the disassociation, and de-authentication may be performed by engine 200 by checking both the Wi-Fi statistics and 5G statistics. In some embodiments, if the 5G statistics are not at a threshold satisfying level, then engine 200 can let the UE stay connected with the Wi-Fi AP even when the link quality (e.g., RSSI, for example) is below a certain threshold. Once the 5G statistics have improved (to at least the threshold level), then the UE can be kicked off the WiFi network and the HO to the 5G network can occur.

In some embodiments, some of the 5G statistics that can be collected from the 5G core can include, but are not limited to, received signal strength indicator (RSSI), reference signal received power (RSRP), quality of experience (QoE), signal to noise ratio (SNR), mobility behaviors, latency, network loads, and the like.

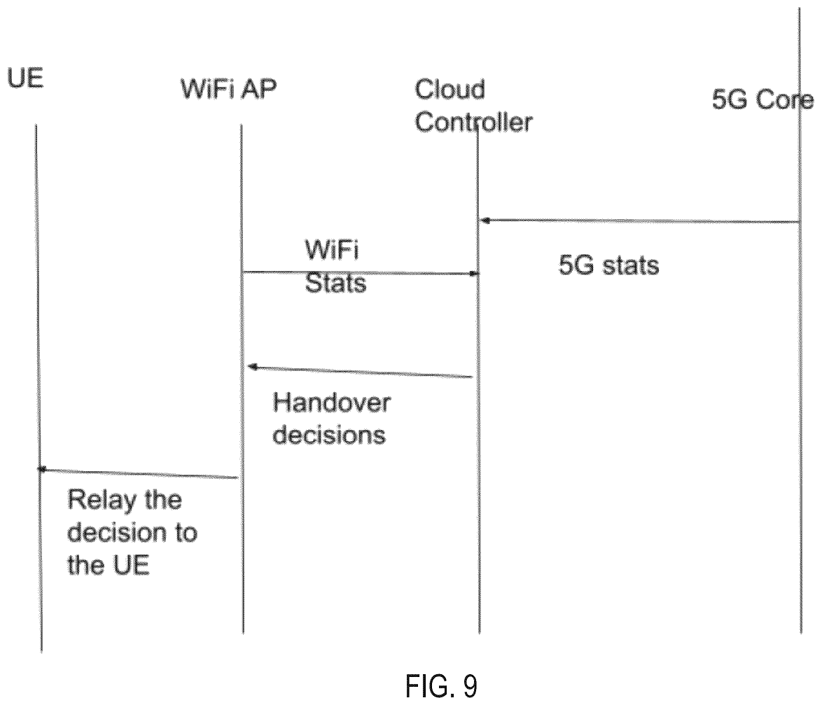

Accordingly, in some embodiments, as mentioned above with reference to Step 504 of Process 500, FIG. 9 depicts mechanisms for engine 200 to collect 5G statistics of the UE from the 5G core of a 5G network. In some embodiments, as per the steps of Process 500, if the AP is hotspot enabled (e.g., hotspot 2.0, for example), then the 5G UE may be authenticated by the WiFi network using 5G SIM credentials.

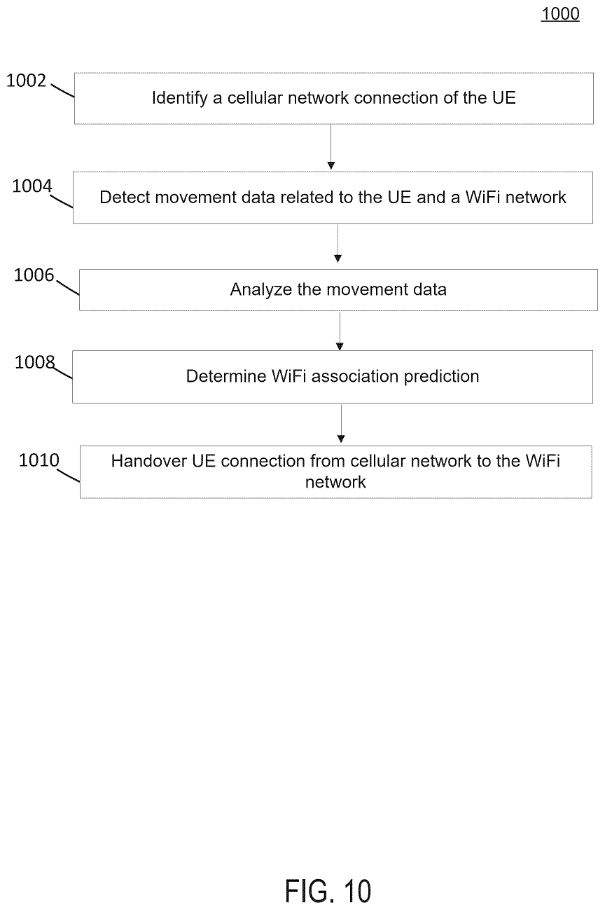

Turning to FIG. 10, Process 1000 provides non-limiting example embodiments for the disclosed network management framework. As discussed herein, the disclosed implementation for Process 1000 relates to an “outdoor to indoor” handover, or, for example, cellular to WiFi handover.

According to some embodiments, Steps 1002 and 1004 of Process 1000 can be performed by identification module 202 of handover engine 200; Step 1006 can be performed by analysis module 204; Step 1008 can be performed by determination module 206; and Step 1010 can be performed by control module 208.

According to some embodiments, Process 1000 begins with Step 1002 where engine 200 can identify a cellular network associated with the UE, whereby the UE is connected to the cellular network (e.g., 5G network). Such connection can be identified in a similar manner as discussed above.

In Step 1004, engine 200 can detect movement data, which can relate to, but not be limited to, the UE and/or a WiFi network (e.g., the smart phone is moving closer to the user's home where they have an established WiFi connection, for example). Such movement data can be similar to the data collected in Step 504 of Process 500, discussed supra. In some embodiments, such data may further involve and/or be related to probe requests for the WiFi network, as discussed below.

In Step 1006, engine 200 can analyze the movement data, which can be performed in a similar manner as discussed above respective to the AI/ML-based analysis as discussed with reference to Step 504, discussed supra. In Step 1008, a determination of a WiFi association prediction can be performed by engine 200, which can be based on the AI/ML analysis in Step 1006. As discussed below, the WiFi association prediction can correspond to a time, distance, expected time/distance for which the UE will be within range to connect to the WiFi network (e.g., within the coverage range, as discussed above). Such prediction can correspond to a disassociation operation, in a similar manner as mentioned above and discussed below.

And, in Step 1010, engine 200 can operate to enable and/or cause a handover between the cellular network to the WiFi network, as discussed below. The handover involve execution of the dissociation (operation) of the cellular network, and authentication and connection to the WiFi network.

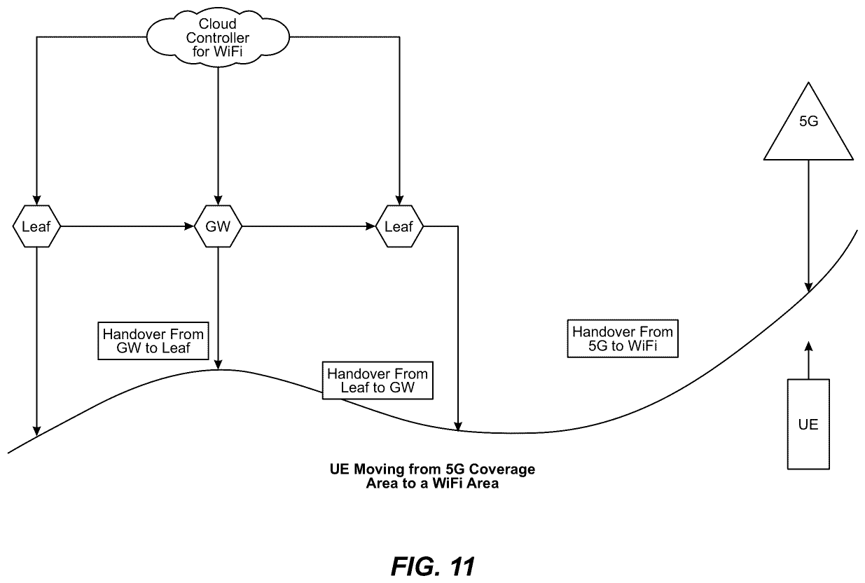

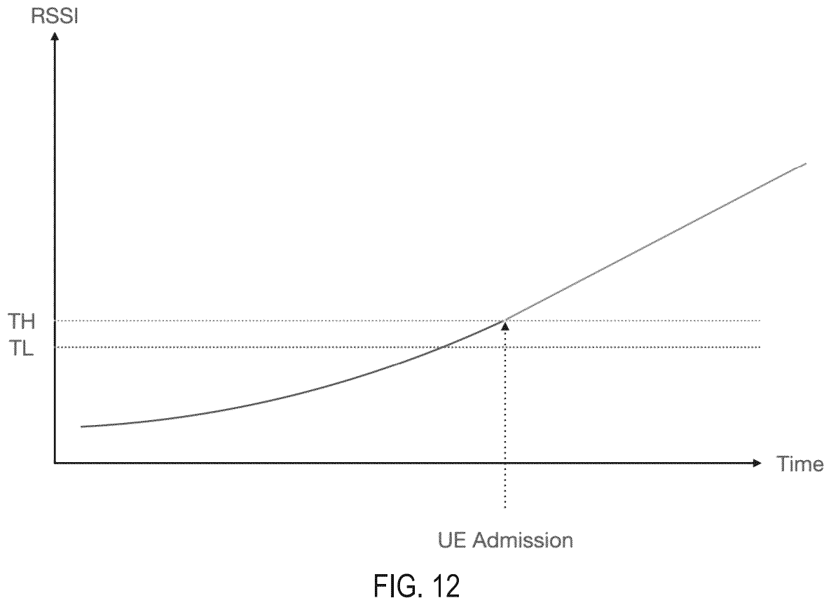

FIG. 11 depicts a non-limiting example embodiment for the performance of Process 1000, where, by way of a non-limiting example, a UE is coming into the home from a 5G network into a home where there is Wi-Fi network coverage. When 5G statistics are not available to engine 200, and when the UE is sending a probe request and probe response, RSSI reports may be stored by engine 200 (in database 108, for example) and AP. If the RSSI starts increasing above a certain threshold(s), the UE may be allowed to attach to the Wi-Fi network.

In some embodiments, as discussed above, if the AP is a hotspot (e.g., hotspot 2.0 AP), then the 5G SIM credentials can be used for further attaching the UE to the Wi-Fi network. According to some embodiments, if it is a legacy UE not using hotspot 2.0 credentials, such as extensible authentication protocol (EAP)-5G credentials, then the UE may be admitted immediately with slightly lower thresholds as well. In some embodiments, for a hotspot enabled UE with EAP 5G based credentials, at the authentication stage, the Wi-Fi AP knows that this UE can connect to both 5G and WiFi. If the statistics are very Weak (e.g., below a threshold to a specific range/value), such a UE may not be admitted by not replying to a probe request, or not authenticating the UE or dissociating the UE after it connects.

According to some embodiments, the UE may be allowed to know its credentials for which the 5G core may be contacted for obtaining more granular 5G statistics. As discussed herein, once this is available, more informed decisions may be made by the Wi-Fi cloud controllers. With access and communication to 5G core and engine 200, the handovers can be seamless, and routing tables may be changed for downlink communication by the 5G core, and for uplink, the UE will change it based on the indications from the 5G UE.

In some embodiments, there may be a learning phase when/where the UE may be enabled to cause engine 200 to learn information about the UE's functionality (e.g., 5G capability, radio access capability, MAC address, and the like).

the UE MAC addresses. Thereafter, the UE WiFi Admission can be controlled, as follows:
i) Ignore Probe Req (if MAC is known);
ii) Ignore Association Req (if MAC is known);
iii) Drop extensible authentication protocol over LAN (EAPOL)-Start Frame thus forcing the authentication process to timeout;
iv) Respond with Invalid Credentials.

In some embodiments, messages/communications can be blocked from the 802.11 protocol to ensure a UE is not allowed to connected to the network, which in some embodiments, can involve simultaneously ensuring that the AP may not blacklist the UE such that the UE can reconnect when it is required/needed (and/or, in some embodiments, requested).

According to some embodiments, the capabilities of the UE can be derived, extracted and/or identified from information elements (IEs) embedded inside messages sent by the UE. For example, a tablet device moving from indoor to outdoor without SIM-card capability will send different IEs compared to a mobile device which has a SIM card. Thus, as discussed above with respect to Steps 1004 and 1006, such IEs can be used as part of the collected and analyzed data to determine WiFi HO operations that are device specific, as in Steps 1008 and 1010.

In some embodiments, there are two (2) cases for which a HO can be effectuated:

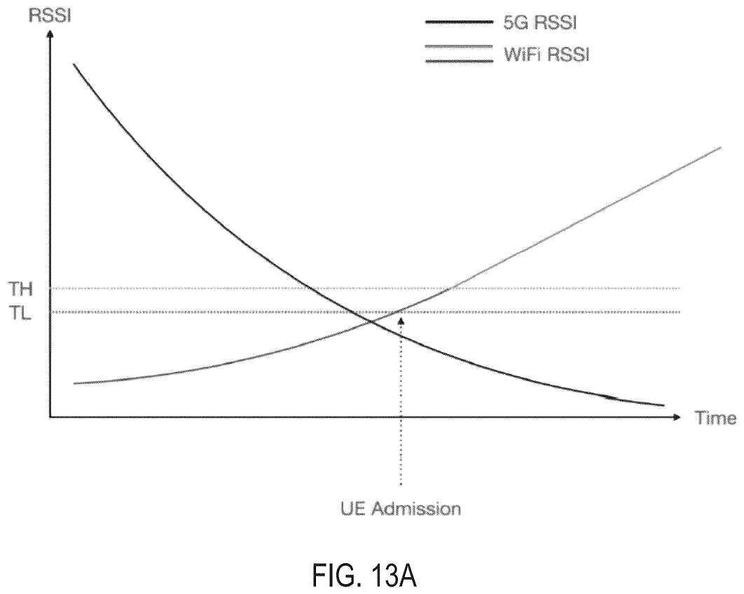

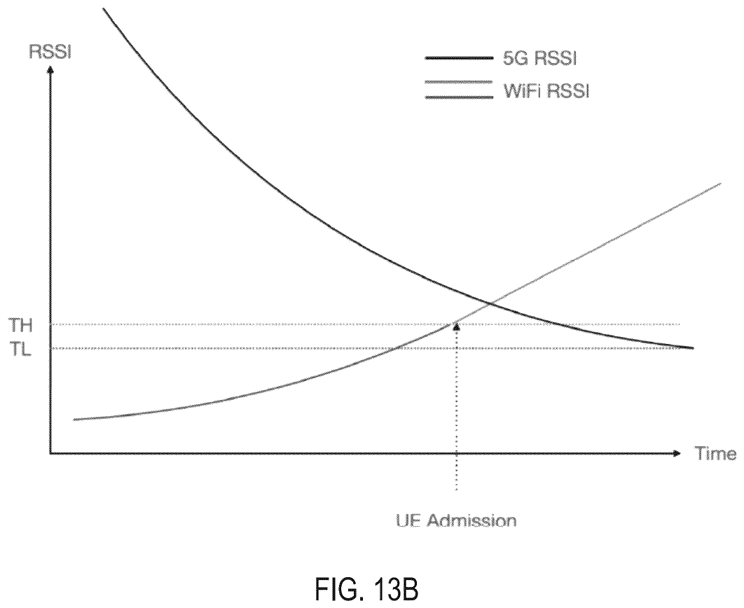

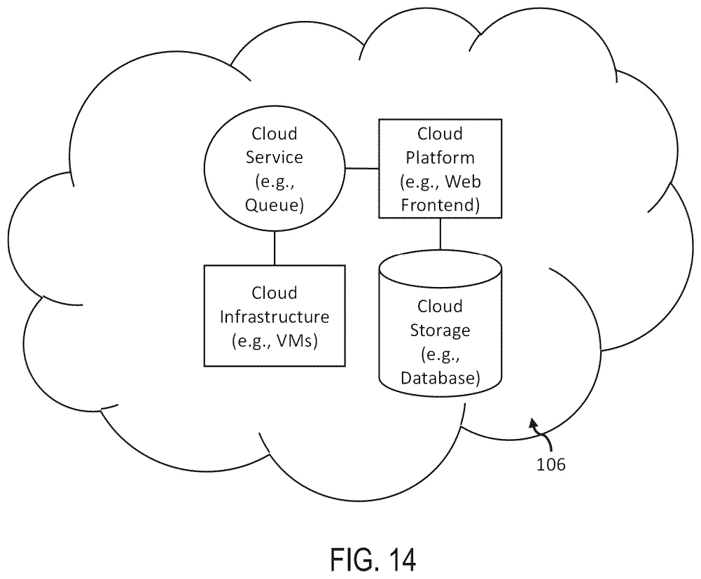

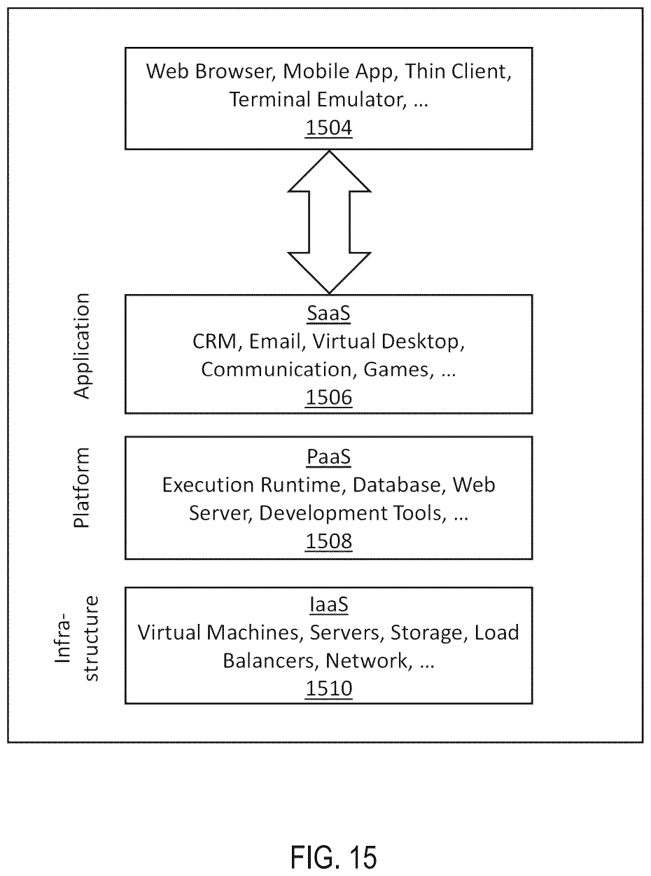

Case 1) If 4G/5G RSSI (or any HO criteria) is better than that of WiFi, the HO is initiated when WiFi crosses up the high threshold (TH), as depicted in FIG. 13A; and

Case 4) When 4G/5G link quality (and/or any type of HO criteria (as discussed supra) and/or radio access network metrics, for example) is worse than that of WiFi, the HO is initiated when WiFi link quality crosses up the low threshold (TL) or even when WiFi link quality is better than 5G, as depicted in FIG. 13B.

Accordingly, in some embodiments, the disclosed AI/ML techniques, discussed above, can be deployed as an AI/ML model via engine 200, whereby engine 200 can train the model to learn how other UEs are operating in similar situations (as derived from similar processes of Processes 500 and 1000), such that the UE can be efficiently and properly handed over to the proper network at the proper time to avoid network disruptions. Thus, the information related to how the HOs are performed for UE can be fed to the model for training and implementation with other UEs and/or other instances of HO for the UE.

As discussed herein, different thresholds can be defined for each specific type of network (e.g., 5G, Wi-Fi, radio access networks (RANs), and the like). As the technologies are different and different transceivers are used on each mode, each modem's ability to handle low signal strengths can be different; therefore, technology specific thresholds may be defined. Accordingly, thresholds can be, but are not limited to, location specific, device specific, region specific (e.g., regulatory and/or compliance-based, and the like, or some combination thereof.

As discussed above, in some embodiments, when there is a single service set identifier (SSID) broadcast by the Wi-Fi AP, then low level IEs can be used for identifying whether the UE is capable of 5G or not. However when multiple SSIDs are used, then, when the UE connects to a specific hotspot 2.0 SSID/Passpoint-enabled SSID (e.g., WiFi Alliance (WFA) protocol), then engine 200 can identify the instant a probe request is received from a specific MAC address that those devices support 5G/other RANs. Accordingly, in some embodiments, a mapping of MAC addresses can be made to store a list of known devices that support such behavior, which can be stored in database 108, as discussed above. In some embodiments, when MAC randomization techniques are used so that a UE uses a random MAC each time it associates with a network, a Radius username/ID can be used to identify UE's with 5G capabilities.

FIG. 16 is a schematic diagram illustrating a client device showing an example embodiment of a client device that may be used within the present disclosure. Client device 1600 may include many more or less components than those shown in FIG. 16. However, the components shown are sufficient to disclose an illustrative embodiment for implementing the present disclosure. Client device 1600 may represent, for example, UE 102 discussed above at least in relation to FIG. 1A.

As shown in the figure, in some embodiments, Client device 1600 includes a processing unit (CPU) 1622 in communication with a mass memory 1630 via a bus 1624. Client device 1600 also includes a power supply 1626, one or more network interfaces 1650, an audio interface 1652, a display 1654, a keypad 1656, an illuminator 1658, an input/output interface 1660, a haptic interface 1662, an optional global positioning systems (GPS) receiver 1664 and a camera(s) or other optical, thermal or electromagnetic sensors 1666. Device 1600 can include one camera/sensor 1666, or a plurality of cameras/sensors 1666, as understood by those of skill in the art. Power supply 1626 provides power to Client device 1600.

Client device 1600 may optionally communicate with a base station (not shown), or directly with another computing device. In some embodiments, network interface 1650 is sometimes known as a transceiver, transceiving device, or network interface card (NIC).

Audio interface 1652 is arranged to produce and receive audio signals such as the sound of a human voice in some embodiments. Display 1654 may be a liquid crystal display (LCD), gas plasma, light emitting diode (LED), or any other type of display used with a computing device. Display 1654 may also include a touch sensitive screen arranged to receive input from an object such as a stylus or a digit from a human hand.

Keypad 1656 may include any input device arranged to receive input from a user. Illuminator 1658 may provide a status indication and/or provide light.

Client device 1600 also includes input/output interface 1660 for communicating with external. Input/output interface 1660 can utilize one or more communication technologies, such as USB, infrared, Bluetooth™, or the like in some embodiments. Haptic interface 1662 is arranged to provide tactile feedback to a user of the client device.

Optional GPS transceiver 1664 can determine the physical coordinates of Client device 1600 on the surface of the Earth, which typically outputs a location as latitude and longitude values. GPS transceiver 1664 can also employ other geo-positioning mechanisms, including, but not limited to, triangulation, assisted GPS (AGPS), E-OTD, CI, SAI, ETA, BSS or the like, to further determine the physical location of client device 1600 on the surface of the Earth. In one embodiment, however, Client device 1600 may through other components, provide other information that may be employed to determine a physical location of the device, including for example, a MAC address, Internet Protocol (IP) address, or the like.

Mass memory 1630 includes a RAM 1632, a ROM 1634, and other storage means. Mass memory 1630 illustrates another example of computer storage media for storage of information such as computer readable instructions, data structures, program modules or other data. Mass memory 1630 stores a basic input/output system (“BIOS”) 1640 for controlling low-level operation of Client device 1600. The mass memory also stores an operating system 1641 for controlling the operation of Client device 1600.

Memory 1630 further includes one or more data stores, which can be utilized by Client device 1600 to store, among other things, applications 1642 and/or other information or data. For example, data stores may be employed to store information that describes various capabilities of Client device 1600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 1600.

Applications 1642 may include computer executable instructions which, when executed by Client device 1600, transmit, receive, and/or otherwise process audio, video, images, and enable telecommunication with a server and/or another user of another client device. Applications 1642 may further include a client that is configured to send, to receive, and/or to otherwise process gaming, goods/services and/or other forms of data, messages and content hosted and provided by the platform associated with engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:

Aspect 1. A method comprising:
monitoring, via a device over a first network, activity data of user equipment (UE), the activity data corresponding to at least movement of the UE in relation to a first zone, the UE connected to the first network;
analyzing, by the device, the activity data, and determining, based on the analysis, that the UE is exiting the first zone;
determining, by the device, based on the exiting of the first zone determination, a dissociation operation;
executing, by the device, the dissociation operation, such that at least one probe is communicated to a second network, the probe comprising a request for connection to the second network upon the UE exiting the first zone and entering a second zone; and
performing, by the device, a handover between the first network and the second network, such that the UE is dropped from the first network and the connected to the second network.

Aspect 2. The method of aspect 1, wherein the handover comprises authenticating the UE with the second network.

Aspect 3. The method of aspect 1, wherein the dissociation operation is based on data related to statistics of at least one of the first network and second network.

Aspect 4. The method of aspect 3, wherein network characteristics are a basis for the dissociation operation when the data related to the statistics are not available, wherein the network characteristics relate at least to link quality of each network.

Aspect 5. The method of aspect 4, wherein the network characteristics are measured against thresholds that are specific to at least one of a type of the UE, location and access mechanism.

Aspect 6. The method of aspect 1, further comprising:
training a model based on handover behaviors of a plurality of behaviors; and
executing the handover of the UE based on the trained model.

Aspect 7. The method of aspect 1, wherein the dissociation operation is based on at least one of a dissociation time, dissociation code and deauthentication operation.

Aspect 8. The method of aspect 1, wherein the handover is further based on a backoff timer that corresponds to whether the UE is capable of being admitted and de-admitted to one of the first and second networks.

Aspect 9. The method of aspect 1, wherein in the first network is a WiFi network, wherein the first zone is a location associated with the WiFi network, wherein the activity data indicates movements of the UE exiting a coverage area of the WiFi network.

Aspect 10. The method of aspect 9, wherein the second network is a cellular network.

Aspect 11. The method of aspect 1, wherein the first network is a cellular network, wherein the exiting of the first zone corresponds to the UE entering a location associated with the second network, wherein the second network is a WiFi network.

Aspect 12. The method of aspect 1, wherein the device is a cloud device that controls the handover of the UE.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
monitoring, via a device over a first network, activity data of user equipment (UE), the activity data corresponding to at least movement of the UE in relation to a first zone, the UE connected to the first network;
analyzing, by the device, the activity data, and determining, based on the analysis, that the UE is exiting the first zone;
determining, by the device, based on the exiting of the first zone determination, a dissociation operation;
executing, by the device, the dissociation operation, such that at least one probe is communicated to a second network, the probe comprising a request for connection to the second network upon the UE exiting the first zone and entering a second zone; and
performing, by the device, a handover between the first network and the second network, such that the UE is dropped from the first network and the connected to the second network.

2. The method of claim 1, wherein the handover comprises authenticating the UE with the second network.

3. The method of claim 1, wherein the dissociation operation is based on data related to statistics of at least one of the first network and second network.

4. The method of claim 3, wherein network characteristics are a basis for the dissociation operation when the data related to the statistics are not available, wherein the network characteristics relate at least to link quality of each network.

5. The method of claim 4, wherein the network characteristics are measured against thresholds that are specific to at least one of a type of the UE, location and access mechanism.

6. The method of claim 1, further comprising:
analyzing the probe request from the UE, the analysis based on determination of a MAC address for the UE;
determining, based on the analysis, an authentication process with regard to a network timeout; and
responding with determined credentials to the second network, wherein the handover is based on admission to the second zone based on the response.

7. The method of claim 1, further comprising:
training a model based on handover behaviors of a plurality of behaviors; and
executing the handover of the UE based on the trained model.

8. The method of claim 1, wherein the dissociation operation is based on at least one of a dissociation time, dissociation code and deauthentication operation.

9. The method of claim 1, wherein the handover is further based on a backoff timer that corresponds to whether the UE is capable of being admitted and de-admitted to one of the first and second networks.

10. The method of claim 1, wherein in the first network is a WiFi network, wherein the first zone is a location associated with the WiFi network, wherein the activity data indicates movements of the UE exiting a coverage area of the WiFi network.

11. The method of claim 10, wherein the second network is a cellular network.

12. The method of claim 1, wherein the first network is a cellular network, wherein the exiting of the first zone corresponds to the UE entering a location associated with the second network, wherein the second network is a WiFi network.

13. The method of claim 1, wherein the device is a cloud device that controls the handover of the UE.

14. A network device comprising:
a processor configured to:
monitor, over a first network, activity data of user equipment (UE), the activity data corresponding to at least movement of the UE in relation to a first zone, the UE connected to the first network;
analyze the activity data, and determine, based on the analysis, that the UE is exiting the first zone;
determine, based on the exiting of the first zone determination, a dissociation operation;
execute the dissociation operation, such that at least one probe is communicated to a second network, the probe comprising a request for connection to the second network upon the UE exiting the first zone and entering a second zone; and
perform a handover between the first network and the second network, such that the UE is dropped from the first network and the connected to the second network, wherein the handover comprises authenticating the UE with the second network.

15. The network device of claim 14, wherein the dissociation operation is based on data related to statistics of at least one of the first network and second network.

16. The network device of claim 15, wherein network characteristics are a basis for the dissociation operation when the data related to the statistics are not available, wherein the network characteristics relate at least to link quality of each network, wherein the network characteristics are measured against thresholds that are specific to at least one of a type of the UE, location and access mechanism.

17. The network device of claim 14, wherein the processor is further configured to:
analyze the probe request from the UE, the analysis based on determination of a MAC address for the UE;
determine, based on the analysis, an authentication process with regard to a network timeout; and
respond with determined credentials to the second network, wherein the handover is based on admission to the second zone based on the response.

18. The network device of claim 13, wherein in the first network is a WiFi network, wherein the first zone is a location associated with the WiFi network, wherein the activity data indicates movements of the UE exiting a coverage area of the WiFi network, wherein the second network is a cellular network.

19. The network device of claim 13, wherein the first network is a cellular network, wherein the exiting of the first zone corresponds to the UE entering a location associated with the second network, wherein the second network is a WiFi network.

20. A non-transitory computer-readable storage medium tangibly encoded with computer-executable instructions that when executed by a device, perform a method comprising steps of:
monitoring, via a device over a first network, activity data of user equipment (UE), the activity data corresponding to at least movement of the UE in relation to a first zone, the UE connected to the first network;
analyzing, by the device, the activity data, and determining, based on the analysis, that the UE is exiting the first zone;
determining, by the device, based on the exiting of the first zone determination, a dissociation operation;
executing, by the device, the dissociation operation, such that at least one probe is communicated to a second network, the probe comprising a request for connection to the second network upon the UE exiting the first zone and entering a second zone; and
performing, by the device, a handover between the first network and the second network, such that the UE is dropped from the first network and the connected to the second network, wherein the handover comprises authenticating the UE with the second network.
